(19) United States
(12) Patent Application Publication
(10) Pub. No.: US 2013/0162630 A1
(43) Pub. Date: Jun. 27, 2013

(54) METHOD AND APPARATUS FOR DISPLAYING STEREOSCOPIC IMAGE CONTENTS USING PIXEL MAPPING

(71) Applicants: Hong-Kee KIM, Daejeon (KR); Seong-Won Ryu, Daejeon (KR); Ung-Yeon Yang, Daejeon (KR); Ki-Hong Kim, Daejeon (KR)

(72) Inventors: Hong-Kee KIM, Daejeon (KR); Seong-Won Ryu, Daejeon (KR); Ung-Yeon Yang, Daejeon (KR); Ki-Hong Kim, Daejeon (KR)

(73) Assignee: Electronics and Telecommunications Research Institute, Daejeon (KR)

(21) Appl. No.: 13/560,043

(22) Filed: Jul. 27, 2012

(30) Foreign Application Priority Data
Dec. 27, 2011 (KR) 10-2011-0143558

(51) Int. Cl. G06T 15/00

(52) U.S. Cl. 345/419

(57) ABSTRACT

A method and apparatus for displaying a stereoscopic image using pixel mapping are provided. The method for displaying the stereoscopic image generates pixel mapping data obtained by mapping a viewpoint position of an observer with pixel information on a screen corresponding to the viewpoint position of the observer using barrier information and panel information, and displays stereoscopic image contents in a pixel area on the screen corresponding to the discerned viewpoint position of the observer based on the generated pixel mapping data. Accordingly, it is possible to prevent distortion of the stereoscopic image by preventing mutually different viewpoints from being mixed.

### CROSS-REFERENCE TO RELATED APPLICATION

This application claims the benefit under 35 U.S.C. §119(a) of Korean Patent Application No. 10-2011-0143558, filed on Dec. 27, 2011, the entire disclosure of which is incorporated herein by reference for all purposes.

### BACKGROUND

1. Field

The following description relates to technology for providing digital contents, and more particularly, to technology for providing stereoscopic image contents based on a parallax barrier scheme.

2. Description of the Related Art

In general, stereoscopic images representing a three-dimensional (3D) space are formed by a principle of stereo vision through both eyes, and binocular disparity occurring due to a distance between both eyes can be regarded as a very important factor of a 3D effect.

Mutually different 2D images are viewed by left and right eyes, these two images are transmitted to the brain via the retina, and the transmitted images are precisely recognized by the brain so that a feeling of depth and presence of the original stereoscopic image is reproduced.

Methods of viewing the stereoscopic image may be classified as stereoscopic schemes or autostereoscopic schemes, depending on whether an observer wears glasses.

In the stereoscopic scheme, there arise problems such as inconvenience because the observer has to wear the glasses, obstruction of vision with respect to objects other than the stereoscopic image when the observer wears the glasses, and the like.

Accordingly, in recent years, research on the autostereoscopic schemes in which glasses are not worn has been actively conducted. A lenticular scheme in which a lenticular lens plate with a cylindrical lens array vertically arranged thereon is mounted on a front side of an image panel, and a parallax barrier scheme, are representative examples of autostereoscopic schemes.

However, distortion of the stereoscopic image may occur due to an arrangement structure of stereoscopic image displays in the autostereoscopic scheme. In the related art, Korean Patent No. 10-0765131 discloses technology for calculating a number of sub pixels to be shifted in accordance with position information of a user, and checking exchange between left and right images by dividing the calculation result by 3, and U.S. Patent No. 2010-0060983 discloses a method for adjusting a barrier using a distance between the left and right eyes and tilt information with respect to the barrier.

### SUMMARY

The following description relates to a method and apparatus for displaying a stereoscopic image using pixel mapping, which may provide clear stereoscopic image contents by preventing distortion of stereoscopic images occurring due to an arrangement structure of stereoscopic image displays.

In one general aspect, there is provided a method for displaying a stereoscopic image by a stereoscopic image display apparatus using a parallax barrier scheme, the method including: generating pixel mapping data by mapping a viewpoint position of an observer with pixel information on a screen corresponding to the viewpoint position of the observer using barrier information and panel information; discerning the viewpoint position of the observer; and displaying stereoscopic image contents in a pixel area on the screen corresponding to the discerned viewpoint position of the observer based on the generated pixel mapping data.

In another general aspect, there is provided an apparatus for displaying a stereoscopic image, including: a stereoscopic image display that includes a panel composed of a plurality of pixels and a parallax barrier that is mounted on a front surface or a rear surface of the panel while being spaced apart from the panel by a predetermined interval; and a processor that generates pixel mapping data obtained by mapping a viewpoint position of an observer with pixel information on a screen corresponding to the viewpoint position of the observer using barrier information and panel information, and outputs stereoscopic image contents in a pixel area on the screen corresponding to a predetermined viewpoint position of the observer through the stereoscopic image display using the generated pixel mapping data when the screen is viewed from the predetermined viewpoint position of the observer.

Other features and aspects will be apparent from the following detailed description, the drawings, and the claims.

### BRIEF DESCRIPTION OF THE DRAWINGS

FIG. 1 is a reference diagram illustrating a principle of a parallax barrier scheme and a stereoscopic image distortion phenomenon of an apparatus for displaying a stereoscopic image to which the present invention is applied;

FIG. 2 is a reference diagram illustrating a state in which distortion of a stereoscopic image becomes more serious with proximity to a peripheral portion of a screen from a center portion thereof in an apparatus for displaying a stereoscopic image in the parallax barrier scheme of FIG. 1;

FIG. 3 is a configuration diagram illustrating an apparatus for displaying a stereoscopic image according to an embodiment of the present invention;

FIG. 4 is a detailed configuration diagram illustrating a processor according to an embodiment of the present invention;

FIG. 5 is a reference diagram illustrating a process for dividing viewpoint positions of an observer into a plurality of numbers according to an embodiment of the present invention;

FIG. 6 is an appearance diagram illustrating a stereoscopic image display according to an embodiment of the present invention;

FIG. 7 is a reference diagram illustrating an example of implementing a parallax barrier scheme for describing a pixel mapping data generation process according to an embodiment of the present invention;

FIG. 8 is a flowchart illustrating a method for displaying a stereoscopic image according to an embodiment of the present invention; and

FIG. 9 is a flowchart illustrating a pixel mapping data generation process according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

Hereinafter, preferred embodiments of the present invention will be described in detail with reference to accompanying drawings.

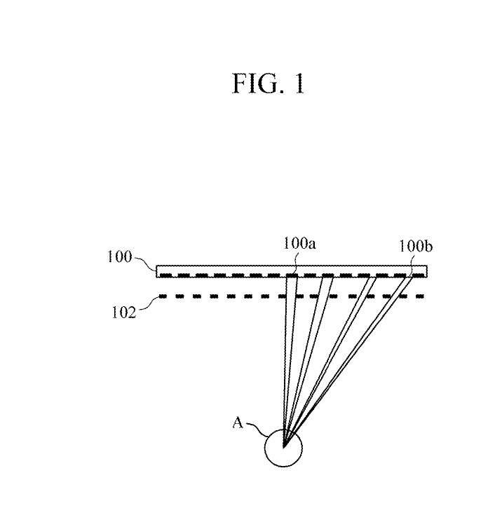

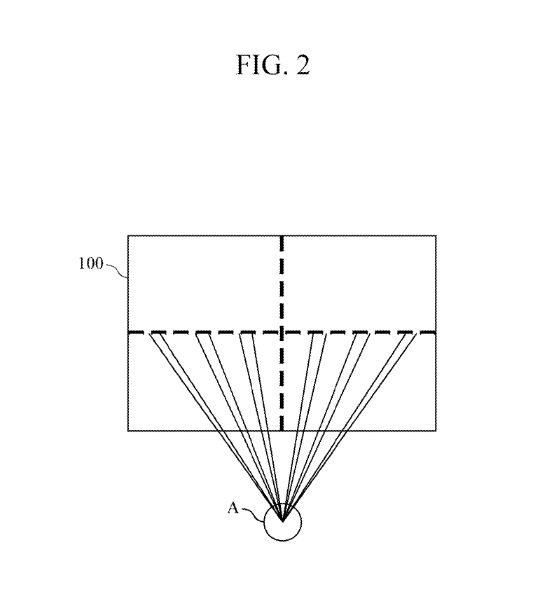

FIGS. 1 and 2 are reference diagrams illustrating a principle of a parallax barrier scheme and a stereoscopic image distortion phenomenon of an apparatus for displaying a stereoscopic image to which the present invention is applied.

As stereoscopic image display schemes, a lenticular scheme and a parallax barrier scheme may be mainly used.

Among theses, a stereoscopic image display of the parallax barrier scheme is designed based on a number of viewpoints, an optimal viewpoint distance, and the like in advance, and displays stereoscopic image contents on a panel screen by mounting a barrier manufactured by the design on a front surface or a rear surface of a panel 100.

However, in the parallax barrier scheme, when the position of an observer viewing a stereoscopic image deviates slightly from the optimal viewpoint distance, the image may appear slightly unnatural. This is because images having mutually different viewpoints interfere within a field of view.

In FIG. 1, when A indicates a position of an eye of an observer, only a single viewpoint should appear to one eye at the moment when a pixel screen 100 is viewed by the observer through a barrier 102.

However, in general, as shown in pixels 100a and 100b of FIG. 1, there are cases in which pixels having mutually different viewpoints are viewed by an observer, or pixels having various viewpoints come into view and interfere. In these cases, the observer feels a distortion phenomenon with respect to a stereoscopic screen, and a degree of the distortion increases with proximity to a peripheral portion of the screen from a center portion thereof as shown in FIG. 2.

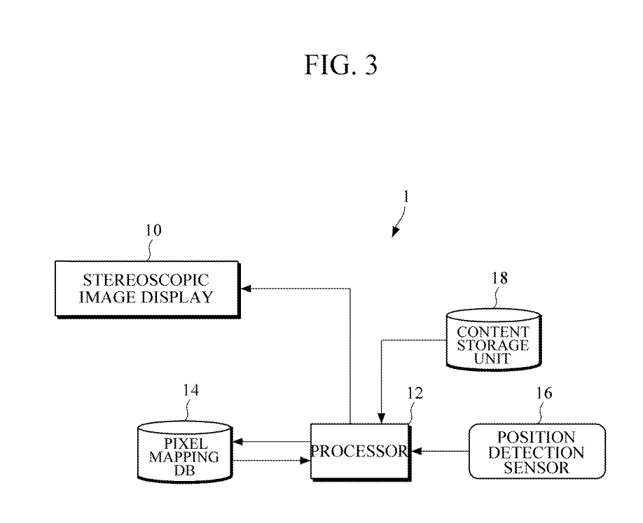

FIG. 3 is a configuration diagram illustrating an apparatus 1 for displaying a stereoscopic image according to an embodiment of the present invention.

The apparatus 1 includes a stereoscopic image display 10, a processor 12, a pixel mapping database (DB) 14, a position detection sensor 16, and a content storage unit 18.

The stereoscopic image display 10 includes a panel 100 composed of a plurality of pixels and a parallax barrier 102 mounted on a front surface or a rear surface of the panel 100 while being spaced apart from the panel 100 by a predetermined interval, and displays stereoscopic image contents on a screen.

The processor 12 generates pixel mapping data. The pixel mapping data is a table obtained by mapping a viewpoint position of an observer with pixel information on a screen corresponding to the viewpoint position of the observer using barrier information and panel information.

The barrier information includes a physical size in width and length of a barrier 102 constituting the stereoscopic image display 10, a width of an opening, and horizontal and vertical resolutions (numbers) of the barrier 102.

The panel information includes a physical size in width and length of a panel 100 constituting the stereoscopic image display 10, horizontal and vertical resolutions (numbers) of the panel 100, and interval information between pixels.

The position detection sensor 16 detects a position of the observer, that is, a viewpoint position from which the observer views the screen.

As the method of detecting the viewpoint position of the observer, general methods capable of measuring the position may be used. For the sake of clarity and concision, these methods will not be described.

The viewpoint position of the observer detected by the position detection sensor 16 is transmitted to the processor 12, which controls the stereoscopic image display 10 so as to output the stereoscopic image contents in a pixel area on the screen corresponding to the viewpoint position of the observer detected by the position detection sensor 16 using the pixel mapping data.

The pixel mapping data may be stored in the pixel mapping DB 14 in advance. In this case, the processor 12 searches for the pixel mapping data corresponding to the viewpoint position of the observer from the pixel mapping DB 14, and outputs the stereoscopic image contents in the pixel area on the screen corresponding to the viewpoint position of the observer from the searched pixel mapping data.

For effective operation, the pixel mapping DB 14 may be configured in a separate memory space, together with the panel as one aggregate piece of hardware, to be operated.

The content storage unit 18 stores the stereoscopic image contents.

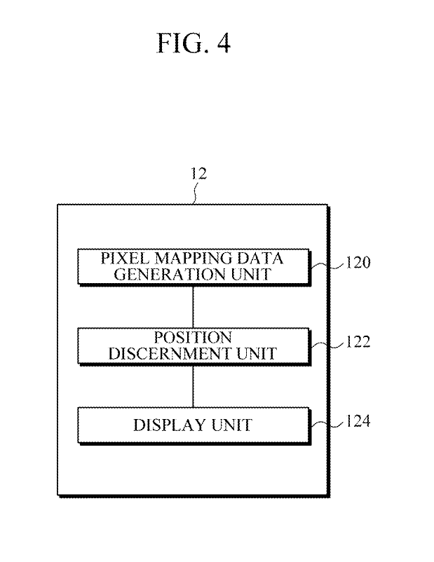

FIG. 4 is a detailed configuration diagram illustrating a processor 12 according to an embodiment of the present invention.

The processor 12 includes a pixel mapping data generation unit 120, a position discernment unit 122, and a display unit 124.

The pixel mapping data generation unit 120 generates pixel mapping data obtained by mapping a viewpoint position of an observer with pixel information on a screen using the barrier information and the panel information.

The position discernment unit 122 discerns the viewpoint position of the observer.

The display unit 124 outputs, through the stereoscopic image display 10, the stereoscopic image contents in the pixel area on the screen corresponding to the viewpoint position of the observer discerned by the position discernment unit 122, based on the pixel mapping data generated by the pixel mapping data generation unit 120.

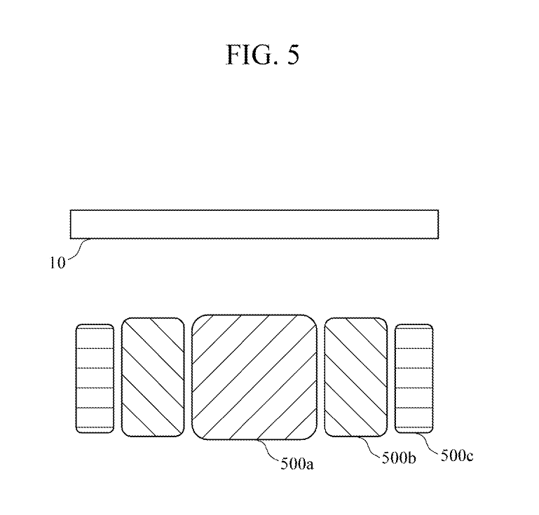

FIG. 5 is a reference diagram illustrating a process for dividing viewpoint positions of an observer into a plurality of numbers according to an embodiment of the present invention.

In order to generate and store pixel mapping data, it is necessary to define the viewpoint position of the observer, which is a position area from which the observer views the stereoscopic image display 10, as shown in FIG. 5.

In FIG. 5, a reference numeral 10 indicates the stereoscopic image display, a reference numeral 500a indicates a viewpoint position of an observer generally watching in front of a panel, and reference numerals 500b and 500c indicate viewpoint positions which are gradually widened from a center to a periphery.

According to an embodiment, for pixel mapping, a priority between the viewpoint positions 500a, 500b, and 500c may be set.

As an example, the priority between the viewpoint positions 500a, 500b, and 500c may be set in the stated order.

In addition, 3D space coordinates are required at regular intervals (for example, units of cm or mm) in each of the viewpoint positions. For this reason, X, Y, and Z position values, which are the 3D space coordinates, are obtained for each viewpoint position of the observer based on the panel, the barrier, and eye positions of the observer.

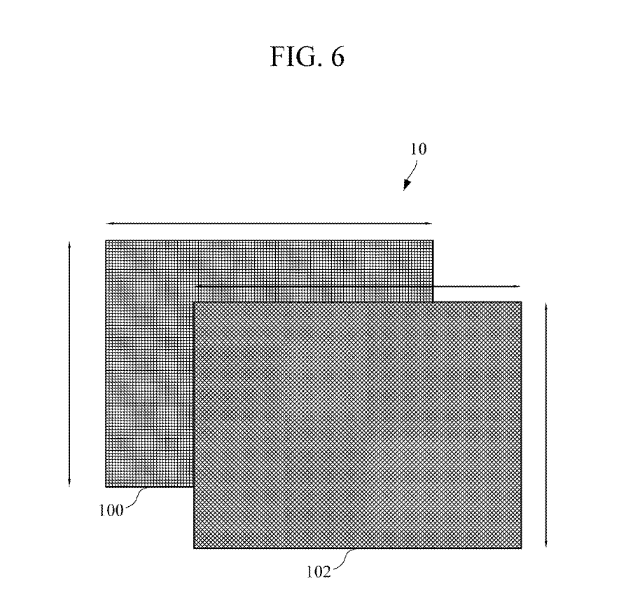

FIG. 6 is an appearance diagram illustrating the stereoscopic image display 10 according to an embodiment of the present invention.

The stereoscopic image display 10 includes a panel 100 composed of a plurality of pixels and a barrier 102 that is mounted on a front surface or a rear surface of the panel 100 while being spaced apart from the panel 100 by a predetermined interval, and displays stereoscopic image contents through a screen of the panel 100.

Barrier information required in the present invention includes a physical size in width and length of the barrier 102 constituting the stereoscopic image display 10, a width of an opening, and a horizontal and vertical resolution (number) of the barrier 102.

In addition, panel information includes a physical size in width and length of the panel constituting the stereoscopic image display 10, a horizontal and vertical resolutions (numbers) of the panel, and interval information between pixels.

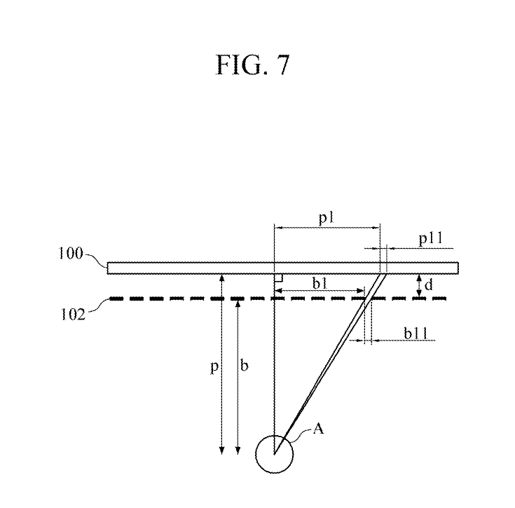

FIG. 7 is a reference diagram illustrating an example of implementing a parallax barrier scheme for describing a pixel mapping data generation process according to an embodiment of the present invention.

In FIG. 7, when an observer views one point of the barrier 102 having the same height as eyes of the observer at the viewpoint position A, which point on the screen of the panel 100 the observer views through a corresponding barrier may be discerned.

First, it is assumed that an observer views a predetermined sub pixel of the panel 100 using a predetermined slit of the barrier 102 in the predetermined viewpoint position A.

In FIG. 7, p denotes a vertical distance between one eye of the observer and the panel 100, b denotes a vertical distance between one eye of the observer and the barrier 102, b11 denotes a slit pitch, b1 denotes a shortest distance from a barrier position forming b to a predetermined slit, p1 denotes a shortest distance from a panel position forming p to a predetermined sub pixel, and p11 denotes a sub pixel pitch. d denotes an interval between the barrier 102 and the panel 100.

The pixel mapping data generation unit 120 calculates b1 using the barrier information.

Next, the pixel mapping data generation unit 120 calculates p1 and p11 using a proportional expression p:b=p1: b1=p1+p11: b1+b11.

Next, the pixel mapping data generation unit 120 generates pixel mapping data by mapping pixel information corresponding to a sub pixel position of p11 with the viewpoint position of the observer.

Next, the pixel mapping data generation unit 120 stores the generated pixel mapping data in the pixel mapping DB 14.

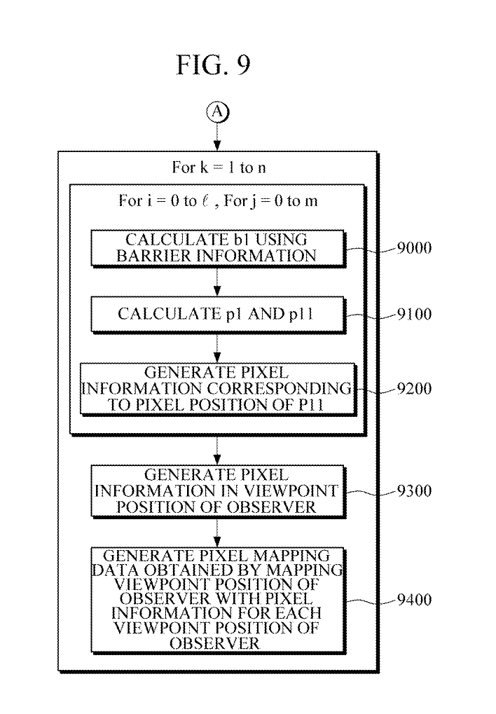

The pixel mapping data generation process will be described in detail with reference to FIG. 9 based on the implementation example of the parallax barrier scheme of FIG. 7.

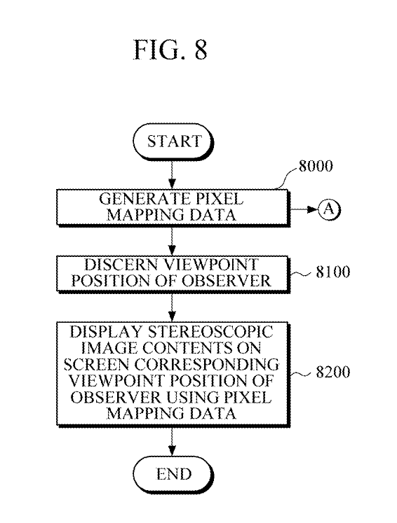

FIG. 8 is a flowchart illustrating a method for displaying a stereoscopic image according to an embodiment of the present invention.

In operation 8000, the apparatus 1 for displaying the stereoscopic image using the parallax barrier scheme generates pixel mapping data obtained by mapping a viewpoint position of an observer with pixel information on a screen corresponding to the viewpoint position of the observer using barrier information and panel information through the pixel mapping data generation unit 120.

The generated pixel mapping data may be stored in the pixel mapping DB 14.

The pixel mapping data generation process will be described in detail with reference to FIG. 9.

Next, in operation 8100, the apparatus 1 discerns the viewpoint position of the observer through the position discernment unit 122.

In operation 8200, the apparatus 1 displays, through the display unit 124, stereoscopic image contents in a pixel area on the screen corresponding to the viewpoint position of the observer discerned through the position discernment unit 122 based on the pixel mapping data generated through the pixel mapping data generation unit 120.

FIG. 9 is a flowchart illustrating a pixel mapping data generation process according to an embodiment of the present invention.

The pixel mapping data generation process of FIG. 9 will be described based on a structure of a stereoscopic image display provided in the form of the parallax barrier of FIG. 7.

In order to generate pixel mapping data for each resolution of the barrier and for each viewpoint position of an observer, the pixel mapping data generation process including operations 9000 to 9400 is repeatedly performed by resolution (1-number) of the barrier in width, by resolution (m-number) of the barrier in length, and by a number of viewpoint positions (n-number) of the observer.

First, in operation 9000, the pixel mapping data generation unit 120 calculates b1 using barrier information.

In this instance, in accordance with geometric principles, a proportional expression p:b=p1: b1=p1+p11: b1+b11 may be established.

Accordingly, in operation 9100, a geometric starting point and end point with respect to p11 may be discerned by the corresponding proportional expression, and pixel coordinates forming p11 in terms of the resolution of the panel may be obtained.

In operation 9200, the pixel mapping data generation unit 120 stores, in the pixel coordinates, pixel information on a screen which an observer views.

Next, referring again to FIG. 9, based on FIG. 7, in operation 9000, the pixel mapping data generation unit 120 calculates b1 using an interval between the barriers and a width of an opening among the barrier information based on a position A of one eye of the observer by resolution (1-number and m-number) of the barrier for each viewpoint position of the observer.

Next, in operation 9100, the pixel mapping data generation unit 120 calculates p1 and p11 using a proportional expression between b1 and b11 and between p and b.

In operation 9200, the pixel mapping data generation unit 120 generates the pixel information corresponding to the pixel position of p11 when p1 and p11 are obtained.

In operation 9300, when operations 9000 to 9200 are performed by the resolution of the barrier (1-number and m-number), the pixel information in the viewpoint position of the observer is generated.

In operation 9400, the pixel mapping data obtained by mapping the viewpoint position of the observer with the pixel information for each viewpoint position by a number of the viewpoint positions (n-number) of the observer is generated and stored.

The pixel mapping DB where the pixel mapping data in accordance with each of the viewpoint positions of the observer shown in FIG. 4 is stored may be constructed by the above-described process.

When the construction of the pixel mapping data is completed, position information of the observer in a predetermined viewpoint position is discerned, the corresponding pixel mapping DB is searched, and stereoscopic image contents are output to a stereoscopic display based on a pixel mapping table.

As described above, according to the embodiments, by displaying the stereoscopic image contents in the pixel area of the screen corresponding to the viewpoint position of the observer, it is possible to prevent mutually different viewpoints from being mixed, thereby preventing a stereoscopic image distortion phenomenon which occurs due to mixed viewpoints.

In addition, the pixel mapping data is configured in advance based on hardware characteristics including the panel information and barrier information of the stereoscopic display for each position where the observer can view the stereoscopic image display, thereby reducing a pixel mapping processing time when the stereoscopic image contents are displayed

In addition, through an adaptive scheme for providing optimal stereoscopic image contents in accordance with each of the viewpoint positions of the observer, clear stereoscopic image contents may be displayed.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for displaying a stereoscopic image by a stereoscopic image display apparatus using a parallax barrier scheme, the method comprising:
generating pixel mapping data by mapping a viewpoint position of an observer with pixel information on a screen corresponding to the viewpoint position of the observer using barrier information and panel information;
discerning the viewpoint position of the observer; and
displaying stereoscopic image contents in a pixel area on the screen corresponding to the discerned viewpoint position of the observer based on the generated pixel mapping data.

2. The method according to claim 1, wherein the barrier information includes a physical size in width and length of a barrier constituting the stereoscopic image display apparatus, a width of an opening, and horizontal and vertical resolutions (numbers) of the barrier.

3. The method according to claim 1, wherein the panel information includes a physical size in width and length of a panel constituting the stereoscopic image display apparatus, horizontal and vertical resolutions (numbers) of the panel, and interval information between pixels.

4. The method according to claim 1, wherein the generating of the pixel mapping data comprises:
calculating b1 using the barrier information;
calculating p1 and p 11 using a proportional expression p:b=p1: b1=p1+p11: b1+b11; and
generating the pixel mapping data by mapping the pixel information corresponding to a sub pixel position of p11 with the viewpoint position of the observer,
wherein, when it is assumed that a predetermined sub pixel of a panel is viewed using a predetermined slit by the observer, p denotes a vertical distance between one eye of the observer and the panel, b denotes a vertical distance between one eye of the observer and a barrier, b11 denotes a slit pitch, b1 denotes a shortest distance from a barrier potion forming b to the slit, p1 denotes a shortest distance from a panel position forming p to a sub pixel, and p11 denotes a sub pixel pitch.

5. The method according to claim 4, wherein the calculating of b1, the calculating of p1 and p11, and the generating of the pixel mapping data are repeatedly performed for each viewpoint position of the observer by resolutions (numbers) of the barrier with respect to horizontal and vertical screens.

6. The method according to claim 1, further comprising:
storing the generated pixel mapping data in a pixel mapping database,
wherein the displaying of the stereoscopic image contents includes searching for the pixel mapping data corresponding to the viewpoint position of the observer from the pixel mapping database, and displaying the stereoscopic image contents in the pixel area on the screen corresponding to the viewpoint position of the observer from the searched pixel mapping data.

7. The method according to claim 1, further comprising:
dividing the viewpoint position of the observer into a plurality of viewpoint positions,
wherein the generating of the pixel mapping data includes mapping the viewpoint position and screen pixel information for each viewpoint position.

8. The method according to claim 7, further comprising:
designating a priority with respect to the plurality of viewpoint positions,
wherein the generating of the pixel mapping data includes generating the pixel mapping data in accordance with the designated priority.

9. An apparatus for displaying a stereoscopic image, comprising:
a stereoscopic image display that includes a panel composed of a plurality of pixels and a parallax barrier that is mounted on a front surface or a rear surface of the panel while being spaced apart from the panel by a predetermined interval; and
a processor that generates pixel mapping data obtained by mapping a viewpoint position of an observer with pixel information on a screen corresponding to the viewpoint position of the observer using barrier information and panel information, and outputs stereoscopic image contents in a pixel area on the screen corresponding to a predetermined viewpoint position of the observer through the stereoscopic image display using the generated pixel mapping data when the screen is viewed from the predetermined viewpoint position of the observer.

10. The apparatus for displaying the stereoscopic image according to claim 9, wherein the processor comprises:
a pixel mapping data generation unit that generates the pixel mapping data obtained by mapping the viewpoint position of the observer with the pixel information on the screen using the barrier information and the panel information;
a position discernment unit that discerns the viewpoint position of the observer; and
a display unit that outputs, through the stereoscopic image display, the stereoscopic image contents in the pixel area on the screen corresponding to the viewpoint position of the observer discerned by the position discernment unit based on the pixel mapping data generated by the pixel mapping data generation unit.

11. The apparatus for displaying the stereoscopic image according to claim 9, further comprising:
a pixel mapping database in which the pixel mapping data is stored,
wherein the processor searches for the pixel mapping data corresponding to the viewpoint position of the observer from the pixel mapping database, and outputs the stereoscopic image contents in the pixel area on the screen corresponding to the viewpoint position of the observer from the searched pixel mapping data.

12. The apparatus for displaying the stereoscopic image according to claim 10, wherein
the pixel mapping data generation unit calculates b1 using the barrier information, calculates p1 and p11 using a proportional expression p:b=p1: b1=p1+p11 :b1+b11, and generates the pixel mapping data by mapping the pixel information corresponding to a sub pixel position of p11 with the viewpoint position of the observer, and
when it is assumed that a predetermined sub pixel of a panel is viewed using a predetermined slit by the observer, p denotes a vertical distance between one eye of the observer and the panel, b denotes a vertical distance between one eye of the observer and a barrier, b11 denotes a slit pitch, b1 denotes a shortest distance from a barrier potion forming b to the slit, p1 denotes a shortest distance from a panel position forming p to a sub pixel, and p11 denotes a sub pixel pitch.

13. The apparatus for displaying the stereoscopic image according to claim 12, wherein, in the pixel mapping data generation unit, the calculating of b1, the calculating of p1 and p11, and the generating of the pixel mapping data are repeatedly performed for each viewpoint position of the observer by resolutions (numbers) of the barrier with respect to horizontal and vertical screens.

14. The apparatus for displaying the stereoscopic image according to claim 10, wherein the pixel mapping data generation unit generates the pixel mapping data by mapping the viewpoint position and screen pixel information for each viewpoint position.

15. The apparatus for displaying the stereoscopic image according to claim 14, wherein the pixel mapping data generation unit generates the pixel mapping data in accordance with a priority with respect to a plurality of viewpoint positions.
